(19) United States
(12) Patent Application Publication
(10) Pub. No.: US 2026/0299677 A1
(43) Pub. Date: Oct. 1, 2026

(54) Emotionally Intelligent Wireless Router with Biometric-Responsive Ambient Interface

(71) Applicant: HARPDOME TECHNOLOGIES INC, USA, WINNIPEG (CA)

(72) Inventors: FELIX OLUBISI BANKOLE, WINNIPEG (CA); OMOLOLA OLA BANKOLE, WINNIPEG (CA)

(73) Assignee: HARPDOME TECHNOLOGIES INC, USA, WINNIPEG (CA)

(21) Appl. No.: 19/253,793

(22) Filed: Jun. 28, 2025

(51) Int. Cl. G06F 3/01; G06F 3/044; H04W 88/18

(52) U.S. Cl. CPC G06F 3/011; G06F 3/044; H04W 88/18

(57) ABSTRACT

A behaviorally adaptive wireless router system is disclosed that integrates biometric sensing, gesture-based input, and ambient visual feedback to promote digital wellness in residential environments. The device comprises a dome-shaped enclosure with a capacitive touch interface, a multi-zone LED ring, and a biometric sync module, all governed by a local-only firmware engine. The system enables users to initiate wellness rituals (e.g., pause, focus, wind-down) through tactile input, while also responding autonomously to physiological signals such as heart rate variability and posture. A companion mobile application supports ritual scheduling, biometric visualization, and mesh coordination across multiple nodes. Unlike conventional routers, the invention operates as a multisensory behavioral interface, delivering non-verbal, emotionally intelligent cues without reliance on cloud-based analytics.

### 2. CROSS-REFERENCE TO RELATED APPLICATIONS (NOT APPLICABLE)

### 3. STATEMENT REGARDING FEDERALLY SPONSORED RESEARCH (NOT APPLICABLE)

### 4. FIELD OF THE INVENTION

The present invention relates to wireless networking systems and, more specifically, to a behaviorally adaptive router that integrates biometric data sensing, gesture-based input, and ambient visual feedback to facilitate emotionally intelligent user interactions and promote digital wellness within residential environments

### 5. BACKGROUND OF THE INVENTION

Conventional wireless routers are designed to optimize data throughput, signal coverage, and device connectivity, but they lack sensitivity to the emotional, behavioral, or physiological context of users. Existing solutions focus primarily on performance metrics, overlooking the rising societal concerns around digital overexposure, screen-time fatigue, and mental wellness. Parental control systems, while widely deployed, tend to be rigid and top-down—relying on content filters or usage blocks that do not foster self-regulation or positive digital habits.

Furthermore, most routers do not incorporate biometric awareness, ambient feedback, or intuitive gesture-based input. Interaction is typically confined to web-based admin portals or mobile apps that are reactive rather than proactive. Features like adaptive behavior, local-only data processing for privacy, and emotion-aligned ambient cues are absent from mainstream devices.

Accordingly, there is a growing need for a next-generation network interface that bridges digital infrastructure with wellness support—one that empowers users of all ages to form healthier relationships with connected technology through adaptive, non-intrusive, and emotionally intelligent feedback mechanisms.

### 6. SUMMARY OF THE INVENTION

The present invention discloses a behaviorally adaptive wireless router system that integrates biometric sensing, gesture-based input, and ambient visual feedback to promote digital wellness in residential environments. Unlike traditional routers that emphasize only performance metrics, this system enables users to initiate or receive non-intrusive, emotionally intelligent cues through capacitive touch interactions and physiological signals.

The device (Henceforth named HarpDome Pulse Router) features a dome-shaped enclosure with a multi-zone ambient LED ring, a capacitive touch surface, and a biometric sync module and a firmware processor that operates locally forms the core of the invention. This configuration allows for real-time nudging behaviors, such as ambient light animations linked to stress levels or screen-time boundaries, without relying on cloud-based analytics. A companion mobile app complements the router's operation by allowing ritual scheduling, biometric visualization, and synchronized mesh coordination across multiple rooms.

By embedding wellness functionality at the network layer and removing punitive parental control models, the invention addresses the need for flexible, inclusive, and emotionally aware technology in modern digital households.

### 7. BRIEF DESCRIPTION OF THE DRAWINGS

FIG. 1 is a perspective view of the HarpDome Pulse Router showing the dome-shaped enclosure, ambient LED ring, and capacitive touch surface.

FIG. 2 is an exploded view of internal components including the LED ring, capacitive sensor layers, printed circuit board, biometric sync module, and power input.

FIG. 3 is a system block diagram illustrating the interaction between gesture input, biometric sensing, firmware processing, ambient feedback, and app communication.

FIG. 4 is a user interaction flow diagram showing the sequence from gesture detection to ritual activation, LED response, and app synchronization.

FIG. 5 is a top-down view of the 12-zone ambient LED ring, with each zone mapped to distinct behavioral states.

FIG. 6 is a mock-up of the companion mobile application interface displaying ritual scheduling, biometric insights, and screen-time trends.

FIG. 7 is a network architecture diagram showing the router's communication with smart home peripherals, biometric input sources, and mesh-linked devices.

FIG. 8 is a schematic diagram illustrating a typical residential deployment of the HarpDome Pulse Router in communication with external devices including mobile phones, wearables, and smart home systems.

### 8. DETAILED DESCRIPTION OF THE EMBODIMENTS

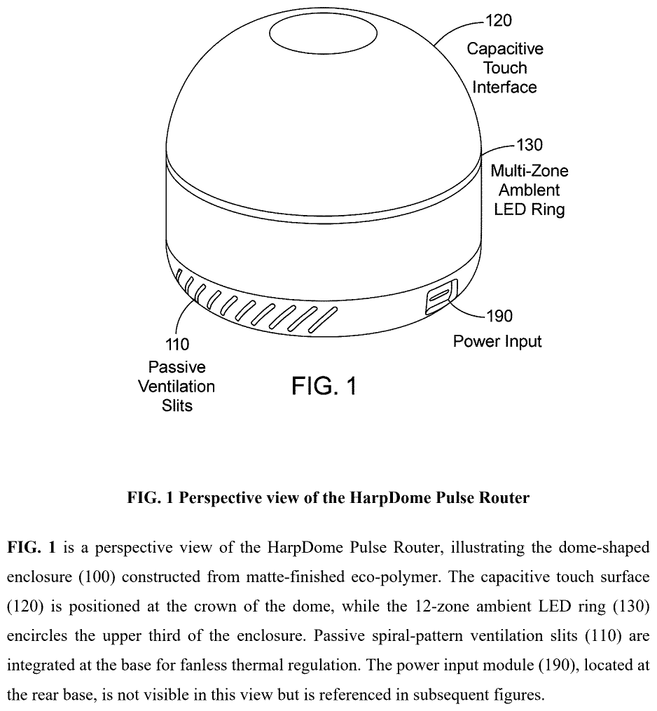

Referring now to the drawings, and in particular to FIG. 1, the HarpDome Pulse Router comprises a dome-shaped enclosure (100) constructed from matte-finished, eco-friendly polymer. Passive spiral-pattern ventilation slits (110) are located at the base, enabling fanless thermal regulation. At the apex of the dome is a capacitive touch surface (120), configured to detect tap, double-tap, and long-press gestures for initiating wellness rituals. A 12-zone ambient LED ring (130) encircles the upper third of the dome and delivers mood-aligned feedback based on user interaction or biometric state.

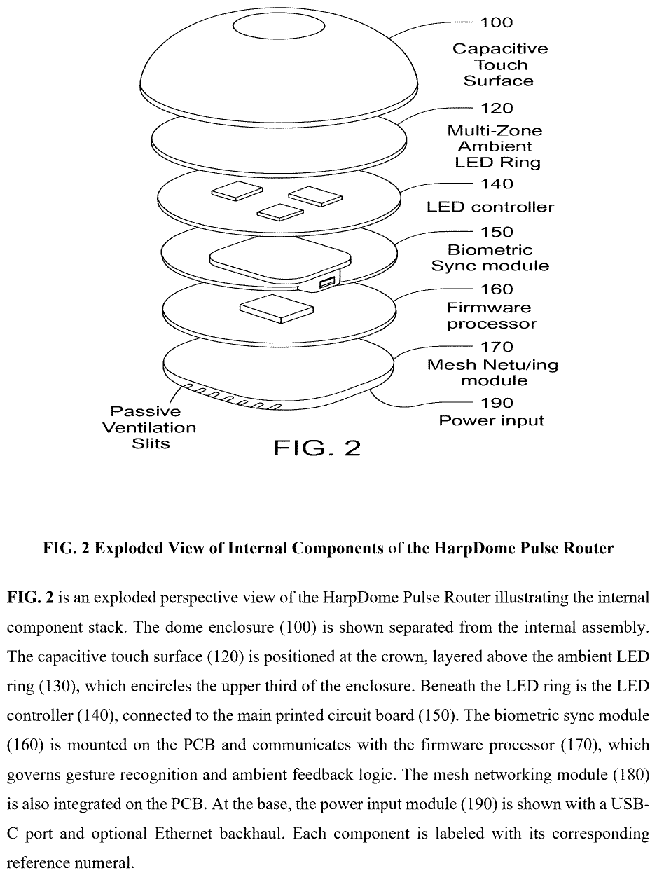

As shown in FIG. 2, internal components include a printed circuit board (150), a biometric sync module (160), a local firmware processor (170), and a mesh networking module (180). The LED ring is controlled by a firmware-linked PWM driver (140), which enables zone-specific animations. Power is supplied via a USB-C input (190) with integrated surge protection; an optional Ethernet port supports backhaul or WAN uplink.

The biometric sync module (160) receives physiological signals—including heart rate variability and posture data—from external wearable devices via Bluetooth Low Energy (BLE). This data is parsed locally by the firmware processor (170), which evaluates user state and triggers ambient nudges when pre-set thresholds are exceeded (e.g., low HRV or prolonged stillness). Gesture input from the capacitive surface (120) is also interpreted by the firmware to activate predefined modes such as Pause, Focus, or Wind-Down.

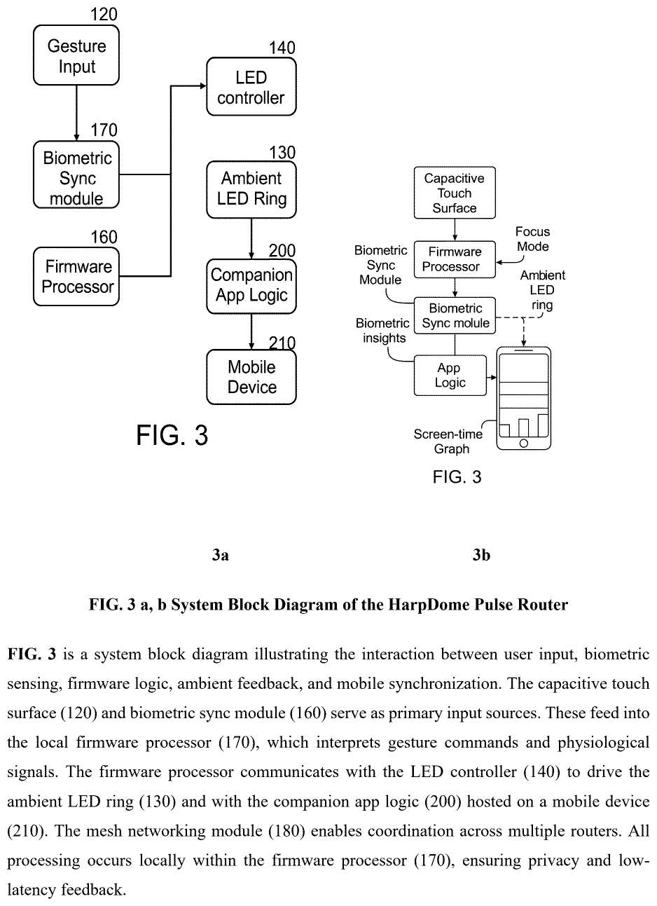

As illustrated in FIG. 3, these inputs are routed to the firmware logic (170), which drives both the LED controller (140) and the companion mobile application (200), hosted on a mobile device (210). The app supports ritual scheduling, biometric insight visualization, and mirrored LED responses.

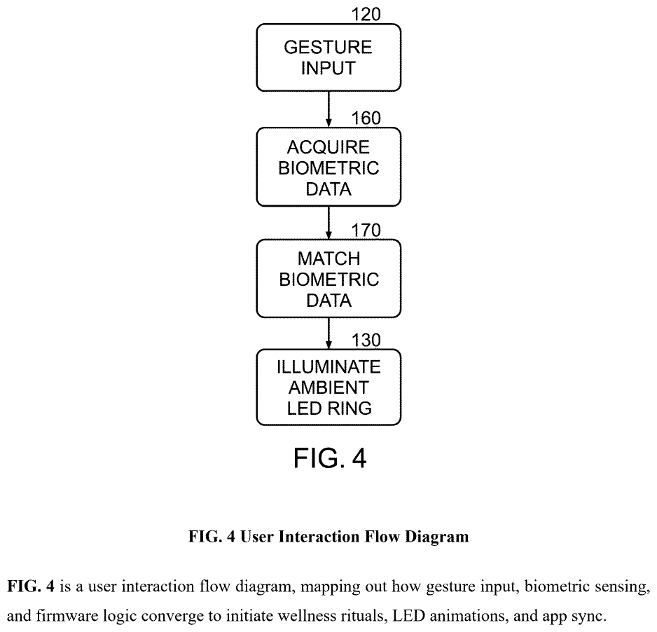

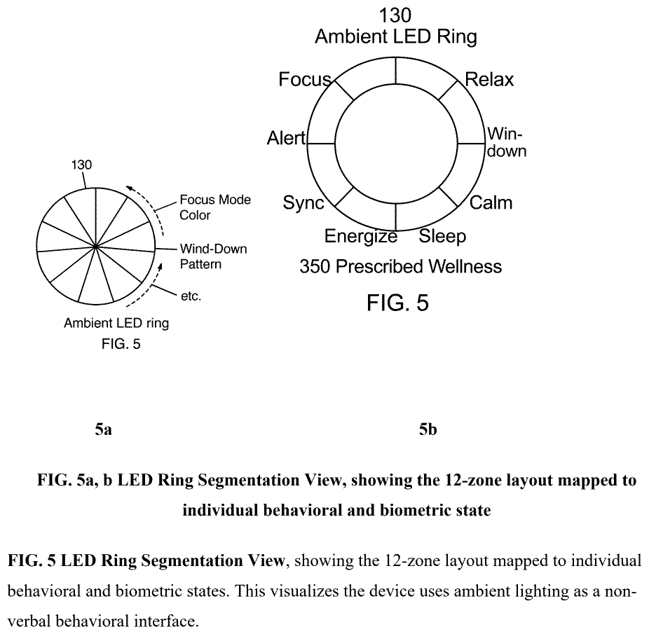

In one embodiment, shown in FIG. 4, a tap gesture initiates a ritual, with the LED ring animating a color-coded response (e.g., blue for Focus, amber for Wind-Down). Simultaneously, the app logs the event and visualizes it in the user's digital wellness timeline. FIG. 5 details the LED ring segmentation, with 12 independently addressable zones used to reflect behavioral or biometric states. Animations include pulsing, rippling, and breathing effects that align with user mood or screen-time context.

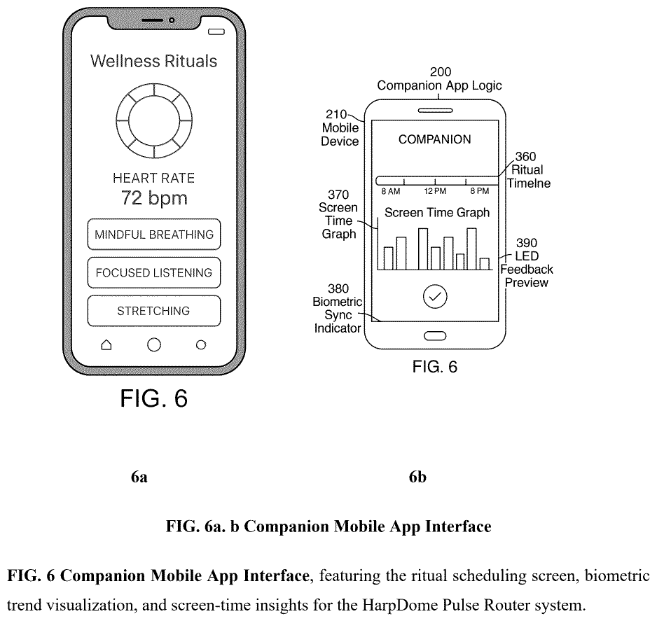

In another embodiment, described in FIG. 6, the app interface displays ritual history, biometric trends, and screen-time analytics. It also allows users to co-create and schedule family-wide routines, offering a collaborative approach to digital well-being.

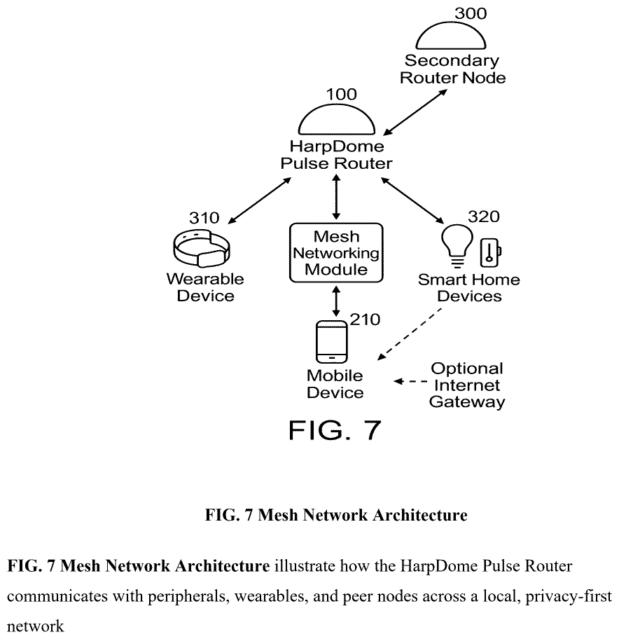

FIG. 7 illustrates the network architecture, highlighting the router's connection to smart home peripherals, biometric input sources, and mesh-linked nodes. Through the mesh networking module (180), rituals triggered on one HarpDome device may be propagated across additional units for whole-home behavioral synchronization.

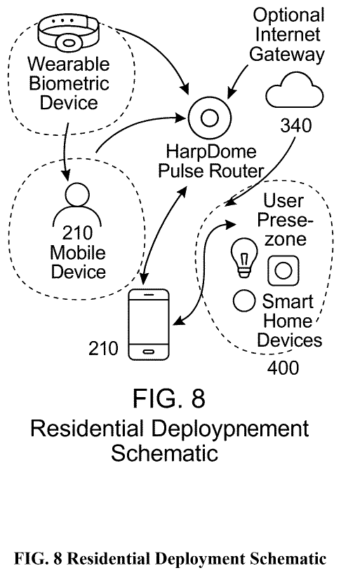

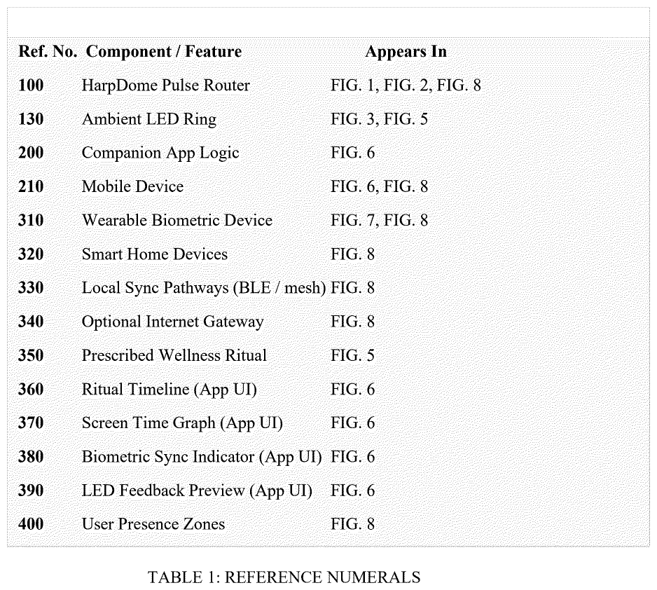

As shown in FIG. 8, the system functions as a central node in a typical residential setup. It communicates bidirectionally with a mobile device (210), smart speakers, displays, wearables, and other devices. Data flows from gesture input or biometric readings to the firmware processor (170), where behavioral logic is executed locally. Non-verbal feedback is then delivered via the LED ring (130), without requiring cloud connectivity.

In one embodiment, the firmware processor (170) may optionally refine nudging behavior based on cumulative user interaction patterns, without invoking cloud-based analytics. This privacy-preserving architecture distinguishes the HarpDome Pulse Router from conventional systems reliant on external servers or static control models.

The above embodiments are provided for illustrative purposes and do not limit the scope of the invention, which is defined by the appended claims.

What is claimed is:

1. A behaviorally adaptive router system, comprising:
a Capacitive Touch Surface (Ref. 120) configured to receive user gestures corresponding to ritual states including Pause, Focus, and Wind-Down;
a Biometric Sync Module (Ref. 160) configured to receive physiological input including heart rate variability and posture data;
a multi-zone Ambient LED Ring (Ref. 130) responsive to user behavior and biometric state;
a Firmware Processor (Ref. 170) configured to operate in a local-only mode and generate screen-time-aware nudges based on gesture and biometric inputs; and
a Mobile Application Interface (Ref. 200) configured to synchronize user interaction data and adapt system behavior based on user interaction patterns.
The system of claim 1, wherein the Capacitive Touch Surface (Ref. 120) triggers a corresponding lighting pattern on the Ambient LED Ring (Ref. 130) and logs a wellness ritual in the Mobile Application Interface (Ref. 200) in response to a detected user gesture.
The system of claim 1, wherein the Biometric Sync Module (Ref. 160) is further configured to initiate a behavioral nudge via the Ambient LED Ring (Ref. 130) when physiological data exceeds one or more thresholds associated with stress, posture deviation, or stillness duration.
The system of claim 1, further comprising a Mesh Networking Module (Ref. 180) configured to propagate ritual activation events and behavioral nudges across multiple HarpDome Pulse Router nodes within a residential environment.
